(19) United States
(12) Patent Application Publication
(10) Pub. No.: US 2011/0272888 A1
(43) Pub. Date: Nov. 10, 2011

(54) Slip joint with clamp

(76) Inventors: Armando Irizzary, Bronx, NY (US); John C. Vincenzi, Valhalla, NY (US)

(21) Appl. No.: 12/932,528

(22) Filed: Feb. 28, 2011

Related U.S. Application Data
(60) Provisional application No. 61/342,278, filed on Apr. 11, 2010.

(51) Int. Cl. F16L 19/065; F16L 21/02; B23P 11/00; F16L 25/00

(52) U.S. Cl. 277/314; 285/354; 285/420; 277/602; 285/419

(57) ABSTRACT

The present invention provides an improved slip joint pipe coupling, which is reinforced by the mechanical compression of a split collar and sealing ring.

### RELATED APPLICATIONS

This application claims priority of U.S. Provisional Application No. 61/342,278 filed on Apr. 11, 2010, the entire contents of which are incorporated herein by reference.

### FIELD OF THE INVENTION

The invention relates to the field of pipe couplings, specifically to adjustable slip joint couplings.

### BACKGROUND OF THE INVENTION

Secure pipe connections for waste lines under sinks, wash basins, tubs, and other appliances can be difficult to make, because the building's waste lines are in fixed positions within the walls, and the basin is often fixed in its position as well by surrounding cabinetry or tiling. The most widely accepted solution has been the use of slip joints, in which a pipe is allowed to telescope within a closely-fitting sleeve, which is usually an integral part of a fitting such as an elbow or trap. Regardless of the relative locations and orientations of the basin and waste line, two or three such telescoping fittings usually provide sufficient degrees of freedom to enable the connection to be made, with no need to cut pipe to precise lengths.

Once the pipes and fittings are properly aligned, a watertight seal between the telescoping components is achieved by means of a compression fitting. A compression nut is threaded onto male threads cut into the exterior of the sleeve, and as the nut is tightened it compresses a sealing ring into the space where the pipe meets the sleeve. Under compression, the ring forms seals against both the sleeve and the inner pipe. Generally, the compression nut has exterior flats, which enable the use of a wrench to tighten the connection. The compression fittings are easily loosened, making it possible to disassemble the plumbing in order to clean or replace components.

The slip joint with compression fittings has provided satisfactory results for over a century (see, e.g., U.S. Pat. No. 337,126, issued in 1886.) For most of the century, however, these results relied upon sturdy pipes and fittings that were forged or cast from heavy iron, copper or brass. The pipes and fittings found in today's construction are often made of very thin metal, or even plastic, and these components are relatively fragile and easily deformed. The thick rubber O-rings and gaskets of the past have in many cases been replaced by less compressible thin plastic rings and washers, which are less tolerant of poor alignment. These relatively delicate joints are usually installed under a kitchen or bathroom sink, a space that is a popular location for storage of detergents, bleach, and other cleaning supplies. The pipes and fittings are subject to being battered and knocked out of alignment as heavy bottles, jugs, and other items are pushed into the under-sink area. The resulting misalignment of the pipes, sleeves, and sealing rings causes the compression fittings to develop leaks. Under-sink leaks can go undetected for some time, resulting in considerable damage to cabinetry, floors, and to whatever lies below.

There is little prospect for the return of sturdy but expensive metal pipes and fittings to the field. There is therefore a need for methods and devices that can establish durable, tight connections between today's lightweight slip joint components.

In pedestal sinks, the compression fittings known in the art are difficult to install because there is little or no room for a wrench; a difficulty that is compounded by the fact that it is difficult to see the fittings at all when they are in place within the pedestal. There is a need for a compression fitting that can be tightened by hand, without tools.

### SUMMARY OF THE INVENTION

The present invention provides a system which meets the aforementioned needs. The system broadly comprises an adjustable length assembly which includes two pipes, a flexible sealing ring, a split collar, and a clamping means. Kits for application to existing piping comprise a split collar and a clamping means, and optionally a flexible sealing ring. The outer pipe has an end within which the inner pipe is telescopically associated. The outer pipe has an external surface with a male thread. The sealing ring, which has an inner diameter equal to or slightly less than the outer diameter of the inner pipe, is slipped over the inner pipe and rests on the end of the outer pipe. The relative position between the two pipes is fixed and maintained by rotating the split collar, which has a threaded interior surface which engages the thread on the outer pipe. The collar has a reduced diameter at one end, and is split by a slot through one side. The slot may be cut at an angle, but is preferably cut along a plane parallel to the axis of the collar, most preferably a plane that includes the axis. Upon being tightened by rotation of the engaged threads, the reduced diameter portion of the collar presses the flexible sealing ring onto the end of the outer pipe, thereby forming a seal. The sealing ring, under this compressive force, expands laterally, creating a seal against the outer surface of the inner pipe. This creates an ordinary slip joint held by a compression fitting, as is well-known in the art.

The collar is then compressed by the clamping means, which reduces the diameter of the collar by bending it so as close the slot. Upon being compressed by the clamp, the collar grips the outer pipe more tightly, and radially compresses the sealing ring against the inner conduit pipe. The resulting assembly provides a strong, rigid joint between the inner and outer conduit pipes that is highly resistant to being put out of alignment. Tightening of the collar and activation of the clamping means can, in preferred embodiments, be accomplished by hand, without the use of tools. These preferred embodiments permit quick and easy installation and disassembly, even in tight and hard-to-see spaces.

### BRIEF DESCRIPTION OF THE DRAWINGS

FIGS. 1A-1C show top, cutaway, and perspective views of the split collar.

FIGS. 2A-2D show top and cutaway views of sealing rings having triangular, flat washer, and circular O-ring geometries.

FIGS. 3A-3F show side and cutaway views of clamping means using a lever.

FIGS. 4A-4B show perspective views of representative worm drive (FIG. 4A) and bolt drive (FIG. 4B) band clamps.

FIG. 5 shows an embodiment of the invention where a clamping means is built directly onto a split collar.

FIGS. 6A-6B show the split collar of FIG. 5 on an inner pipe, in clamped (FIG. 6B) and unclamped (FIG. 6A) states.

FIG. 7 is a cross-section showing the collar, sealing ring, and clamping means in place on a slip joint.

### DETAILED DESCRIPTION OF THE INVENTION

In a slip joint comprising an inner pipe telescopically associated with an outer pipe, and a compression fitting comprising a collar threaded onto the end of the outer pipe and a flexible sealing ring compressed by the collar against the outer pipe and forming a seal against the outer wall of the inner pipe, the invention provides an improvement which consists of a split collar, and a means for axially compressing said split collar.

The invention further provides a kit for preparing a compression fitting, comprising a split collar and a means for compression of said split collar. The invention further provides a method for sealing an inner pipe to an outer pipe in a slip joint, which comprises the steps of slipping a flexible sealing ring around the inner pipe, compressing said sealing ring against the end of said outer pipe by threading a split collar onto said end of said outer pipe, and compressing said split collar with a means for compression.

In a particular embodiment, the means for compression comprises a lever arm. In other embodiments, the means for compression comprises a flexible band clamp.

A selection of exemplary embodiments of the present invention will now be described in detail, with reference to the Figures. The Figures and this description do not constitute or define limits to the scope of the invention, but are intended only to provide illustrative examples.

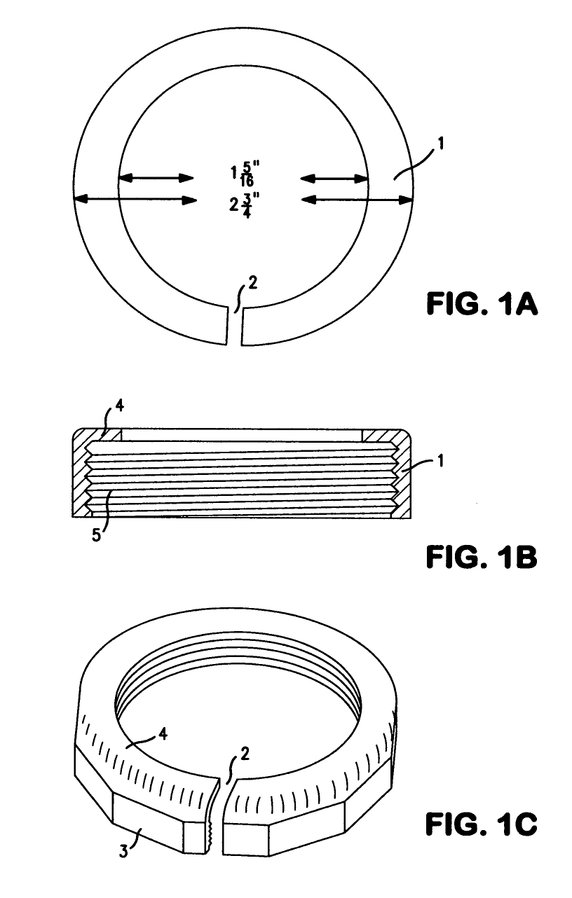

FIG. 1A shows a top view of a split collar 1 of the invention, having a slot 2 cut therein, the plane off the cut preferably being perpendicular to the plane of the collar. The precise width of the slot 2 is not critical, and will typically range from about 3/16 inch to about ¼ inch for a 1¼ inch pipe fitting. As shown in FIG. 1C, the collar preferably has flats 3 formed along the outer surface, to provide for tightening by a wrench. The outer surface may optionally be knurled, or feature raised ridges, to assist in tightening by hand. As shown in FIG. 1B, one end of the collar has a flange or rim 4 extending radially inward from the perimeter, and interior female threads 5 extending from the other end. The various embodiments of the split collar of the invention are substantially identical to collars for compression fittings sold commercially, the principal difference being the presence of the slot 2.

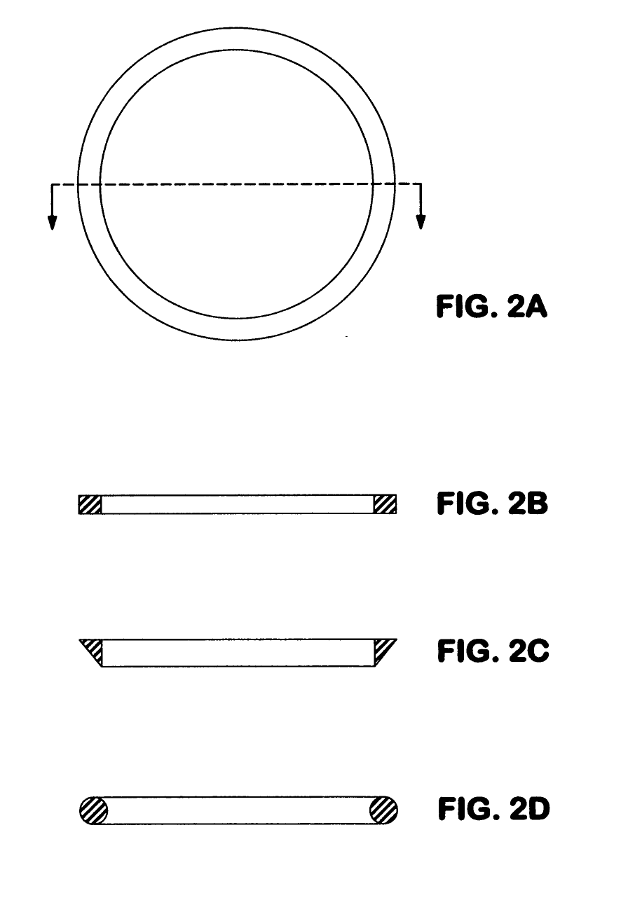

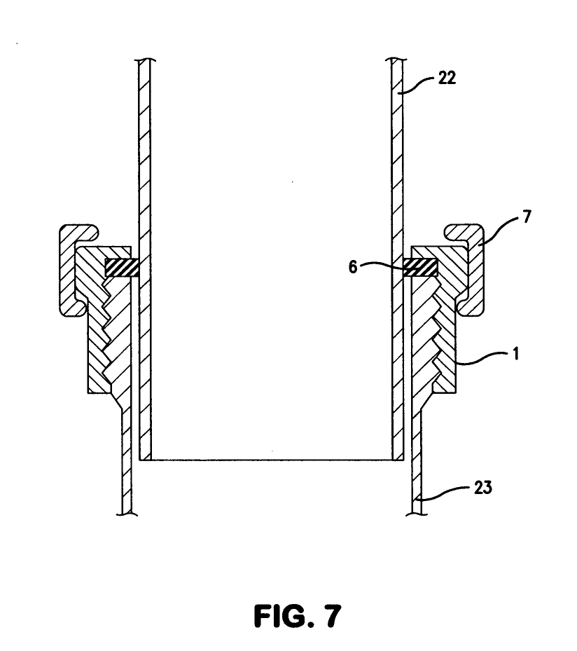

FIG. 2A shows a top view of a sealing ring 6, with dimensions suitable for use in a 1¼ inch fitting. The sealing ring may have any of a variety of cross sections, and will be determined in part by the geometry of the outer pipe, as is known in the art. Representative cross sections are a rectangular cross section shown in FIG. 2B, typically used for flat rubber or elastomer washers, a triangular shape, shown in FIG. 2C, as is used in the art for polymer sealing rings; and a circular cross section shown in FIG. 2D, typical of elastomer O-rings. The triangular-sectioned rings are designed to be pressed into the space between the inner and outer pipes upon tightening of the collar, and are appropriate where there is a bevel within the end of the outer pipe. The preferred cross sections, particularly where the end of the inner pipe presents a flat surface, are rectilinear, or otherwise present at least one right angle, so as to more thoroughly engage with the outer surface of the inner pipe and the end surface of the outer pipe, as shown in FIG. 7.

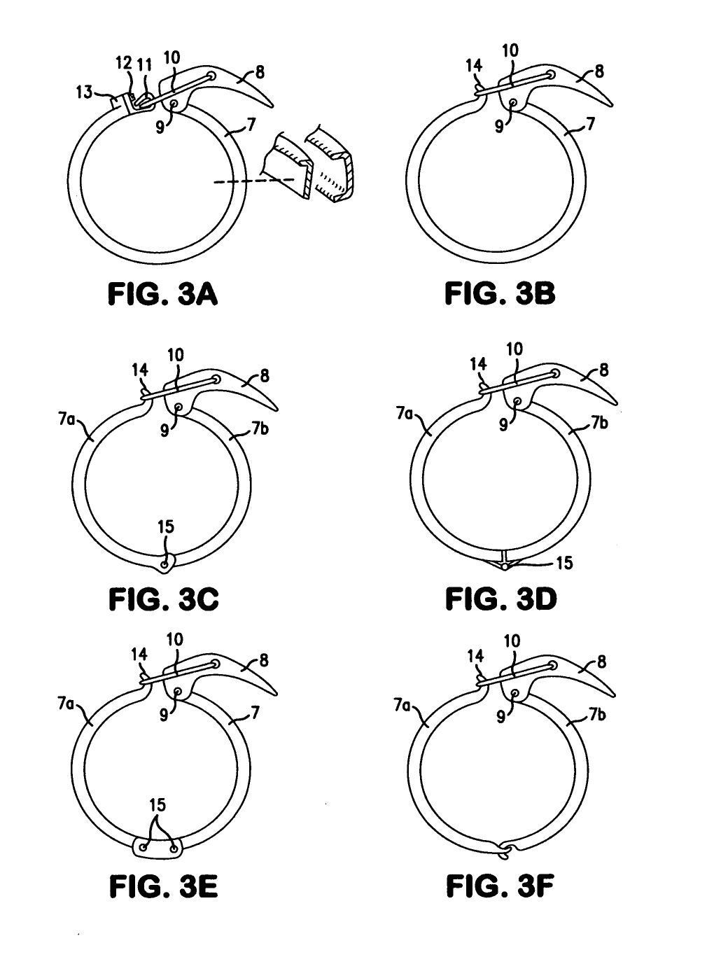

FIGS. 3A-3F show representative embodiments of the clamping means, which employ a lever lock mechanism. A metal band 7 is formed into a circular shape having a diameter slightly greater than that of the collar 1, and has a flap or lever 8 rotatably attached by a hinge 9 to a first end of the band. The lever 8 bears a link 10, which passes through clamp union 11. Union 11 is attached to the second end of the band 7 by means of screw 12, which engages a threaded anchor 13 formed into the second end of the band. Rotation of the lever 8 against the body of the clamp 7 pulls the ends of the band together, tightening the clamp. In cross section, the band 7 may be flat, but is preferably C-shaped or L-shaped, as shown in the cutaway views of FIG. 3A. Intermediate shapes are of course possible. These cross sections assist the practitioner in properly aligning the clamp with the split collar prior to tightening the clamp. FIG. 3B shows an alternative embodiment, in which the link 10 engages with an open hook 14 formed into the second end of band 7. This embodiment can be put in place after the compression fitting is assembled. FIG. 3C shows an embodiment wherein the band 7 is split into two segments 7a and 7b, which are joined by a hinge 15. FIGS. 3D and 3E illustrate alternate hinge designs. FIG. 3F shows a split band where the segments are joined by means of a hook and slot.

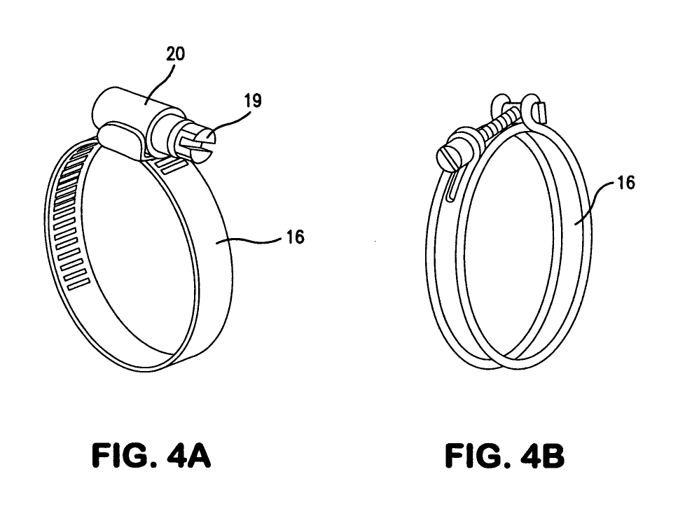

FIG. 4A shows an alternative clamping means, which is a flexible band clamp. The clamp features a thin steel band 16 having slots cut into at least the second end portion. The slots engage the threads of a tightening screw 19, which is retained in a freely rotatable manner in a housing 20 attached to the first end of the band. FIG. 4B shows a band clamp with a bolt drive. Components for these and other designs are readily available items of commerce.

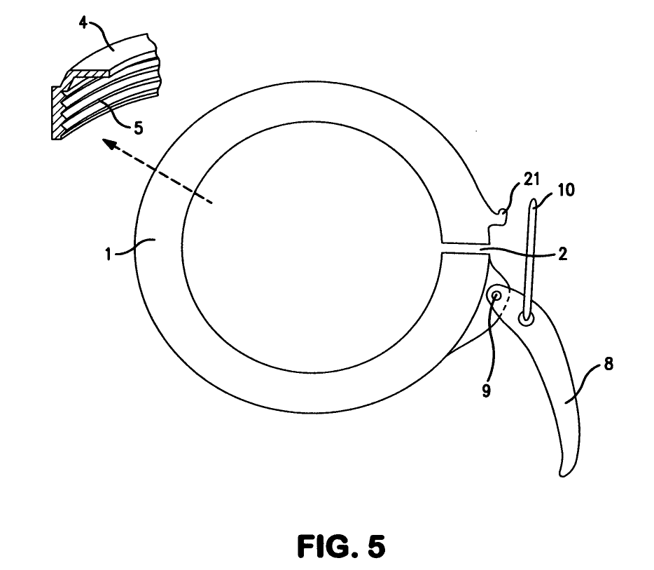

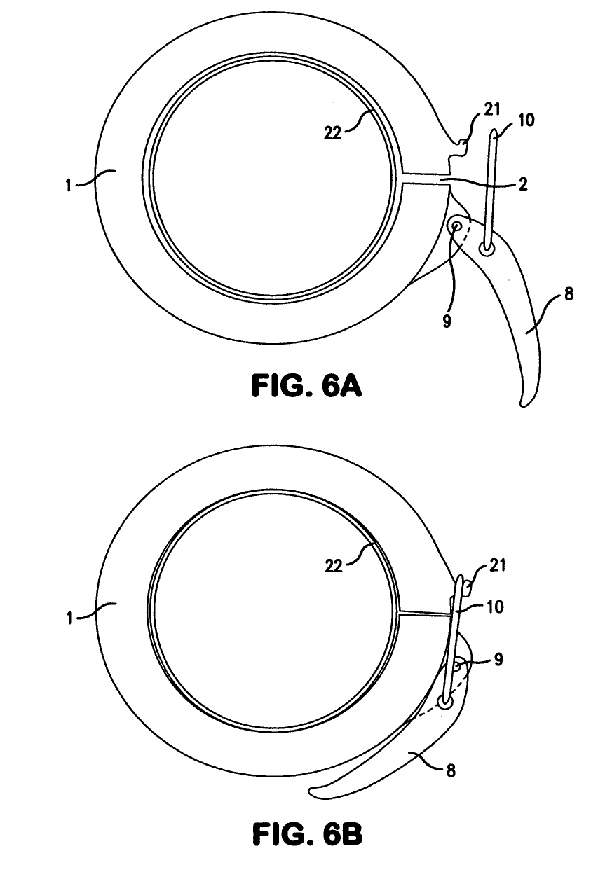

FIG. 5 shows an embodiment in which the clamping means is built onto the collar. Lever 8 is rotatably attached to the collar by hinge 9, located close to the slot 2. A hook 21 is formed in the collar on the opposite side of slot 2. When link 10 is engaged with hook 21, closing lever 8 against the body of the collar bends the collar so as to close the slot, thereby reducing the inner diameter of the collar. FIGS. 6A-B show the split collar in clamped and unclamped states around the inner pipe 22. FIG. 7 is a cross section showing the collar 1, sealing ring 6, and clamping means 7, in place on a slip joint between the inner pipe 22 and outer pipe 23.

The invention is operated by using the split collar of the invention to assemble a compression fitting on a slip joint, as is known in the art. Tightening the collar by screwing it down on the threaded outer pipe provides a compressive force on the sealing ring perpendicular to the plane of the ring, creating a seal against the outer pipe. The clamping means of the invention is then used to compress the collar, which closes the slot and reduces the inner diameter of the collar. This provides a compressive force on the sealing ring that is directed radially inward, compressing the sealing ring against the outer surface of the inner pipe so as to form a tight seal. A tighter seal of the ring against the collar is also produced, with the net result being a tighter grip between the inner and outer pipes. The grip of the collar on the outer pipe is likewise improved. The tighter seals, and the tighter grips, produce a joint that is extremely resistant to loosening of the collar, resistant to axial slippage of the pipes, and resistant to displacement or off-axis bending of the pipes as well. The absence of relative motion between the pipes enables the sealing ring to better maintain a watertight seal.

The system of the invention has several advantages in addition to the tighter and more durable seal. The collar may be hand-tightened without the use of wrenches, and the lever-operated compression means may be snapped shut by hand as well, which is an advantage in tight quarters. Elimination of tools, especially in tight spaces, results in a much faster assembly, reducing labor costs. This can yield significant savings in the construction of a large apartment building, where hundreds of such connections must be made. Disassembly, for example to clean out a trap, is likewise readily accomplished by hand, without tools, even in tight quarters.

As used herein, the term “pipe” refers not only to isolated sections of pipe, but also to the pipe-like portions of fixtures and fittings. In particular, references to the “outer pipe” include the pipe-shaped sleeve portions or extensions of traps, elbows, tees, couplings, and the like, and the term refers generally to any portion of pipe designed (or intended by the practitioner) to serve as the outer member or sleeve of a slip joint. References to the “inner pipe” likewise refer to pipe and pipe-shaped portions or extensions of sinks, tubs, urinals, and fittings such as traps, elbows, tees and couplings, and the term generally refers to any portion of pipe designed (or intended by the practitioner) to serve as the inner member of a slip joint.

The terms “clamping means” and “means for compression” are used interchangeably, and refer generally to any device or mechanism that is capable of applying a compressive force to the split collar of the invention, so as to induce a closing of the slot and a reduction in the diameter of the collar. The term is specifically intended to encompass both clamping means that are built into or onto the collar, i.e., the means for compression and the collar together constitute a single mechanical device; and clamping means that are a mechanical device or devices separate from the collar. The mechanism by which the clamping means applies a compressive force is not critical. Lever arms (as used, for example, in so-called “snap” coupling clamps) are preferred, for their ease of use, speed, and tool-free installation, but clamps that are tightened by means of screws, bolts, ratchets, worm drives, T-bolts and the like, as are known in the art, may be employed. Heat-shrinkable polymer band clamps (e.g., PowerGrip™ SB clamps, Gates Corp., Denver Colo.) may be employed, although it will be appreciated that they are not re-usable. All known designs of snap couplings; hose and tubing clamps, including Snapper™ (HellermannTyton N.A., Milwaukee, Wis.), worm drive, bolt drive, and other flexible band clamps; and V-clamps are contemplated to be suitable or adaptable as clamping means for use in the invention, and are within the definition of “means for compression” or “clamping means”.

The clamping means may comprise a single band 7, if the band is of sufficiently flexible construction, or it may comprise a hinged band having two or more segments, for example the two segments 7a and 7b, having hinged connections between them. When the band comprises rigid segments, hinged and segmented bands make it easier to place the clamping means in position over the collar, and are particularly advantageous if one wishes to apply a clamping means to a split collar that is already installed. Flexible band clamps, for example plastic straps and stainless steel bands on the order of 0.7 mm thickness, are likewise capable of installation on already-assembled joints.

The pitch and angle of the threaded portion 5 of the collar are not critical, but are preferably chosen to mate with the complimentary male threads on commercially available slip joint compression fittings. The collar is preferably made of metal, for example brass, ductile iron, or mild steel, but may be of any suitable material, including but not limited to hard rubbers or polymers such as polypropylene, polyamide, polyimide, POM, ABS, and PVC. Polymers may optionally be filled or reinforced with fibers, such as for example glass, polyimide, and carbon fibers.

The illustrations and examples provided herein show dimensions appropriate to 1¼ inch piping. The invention is equally applicable to other sizes, with appropriate scaling of the components, and it is intended that the scope of the claims will encompass other sizes, including but not limited to 1½ inch, 2-inch, and metric sizes. In one illustrative embodiment of the invention, the 1¼ inch and 1½ inch collars have the same outer diameter, so that a single clamping means can be employed on fittings of either size. In yet another embodiment, the sealing ring has an inner diameter of about 1¼ inches and an outer diameter suitable for sealing against the end of a 1½ inch outer pipe. A collar threadable on the 1½ inch pipe, preferably having an inner diameter of about 1 5/16 inches, can be used to form a joint between the two sizes. The pipes may be maintained in a parallel and concentric relationship by insertion of a close-fitting cylindrical sleeve into the annular space *between them, or by insertion of a cylindrical extension of the sealing ring.

The width of the slot cut into the collar is not critical, but it is preferably chosen so that when the collar is fully compressed, and the slot is fully closed, the inner diameter of the collar is not reduced to less than the outer diameter of the inner pipe. Too tight a grip on the inner pipe may stress the pipe at the points of contact, increasing the risk of fracture. It is preferable that a slight gap, on the order of 0.01 to 0.04 inches, remains between the collar and the inner pipe when the collar is compressed. This gap allows the sealing ring to absorb small motions and vibrations, making the joint less rigid and the components less susceptible to flexion and metal fatigue. By way of example, for a collar having a 1 5/16 inch ID, a slot between 3/16 inch and ¼ inch is suitable for assembly of 1¼ inch fittings.

It will be appreciated that complete compression, so as to fully close the slot, is not required for operation of the invention. Any degree of radial compression of the sealing ring against the inner pipe that is produced by compression of the split collar will produce an improved seal, and an improved joint according to the present invention.

We claim:

1. In a slip joint comprising an inner pipe telescopically associated with an outer pipe, and a compression fitting comprising a collar threaded onto the end of the outer pipe and a flexible sealing ring compressed by said collar against said outer pipe and forming a seal against the outer wall of said inner pipe; the improvement consisting of a split collar, and a means for compression of said split collar.

2. The improvement according to claim 1, wherein the means for compression and the collar constitute a single device.

3. The improvement according to claim 1, wherein the means for compression and the collar are separate devices.

4. The improvement according to claim 1, wherein the means for compression comprises a lever arm.

5. The improvement according to claim 1, wherein the means for compression comprises a flexible band clamp.

6. A kit for making a compression fitting, comprising a split collar and a means for compression of said split collar.

7. The kit according to claim 6, wherein the means for compression and the collar constitute a single device.

8. The kit according to claim 6, wherein the means for compression and the collar are separate devices.

9. The kit according to claim 6, wherein the means for compression comprises a lever arm.

10. The kit according to claim 6, wherein the means for compression comprises a flexible band clamp.

11. The kit of claim 6, further comprising a flexible sealing ring.

12. The kit of claim 7, further comprising a flexible sealing ring.

13. The kit of claim 8, further comprising a flexible sealing ring.

14. The kit of claim 9, further comprising a flexible sealing ring.

15. The kit of claim 10, further comprising a flexible sealing ring.

16. A method for forming a seal between an inner pipe and a telescopically associated outer pipe in a slip joint, which comprises the steps of placing a flexible sealing ring around the inner pipe, compressing said sealing ring against the end of said outer pipe by threading a split collar onto said end of said outer pipe, and compressing said split collar with a means for compression.

17. The method of claim 16, wherein the means for compression and the collar constitute a single device.

18. The method of claim 16, wherein the means for compression and the collar are separate devices.

19. The method of claim 16, wherein the means for compression comprises a lever arm.

20. The method of claim 16, wherein the means for compression comprises a flexible band clamp.
